(19) United States
(12) Patent Application Publication
(10) Pub. No.: US 2025/0209699 A1
(43) Pub. Date: Jun. 26, 2025

(54) IMAGE GENERATION METHOD AND DEVICE AND COMPUTER-READABLE STORAGE MEDIUM

(71) Applicant: UBTECH ROBOTICS CORP LTD, Shenzhen (CN)

(72) Inventors: YUSHENG ZENG, Shenzhen (CN); Xilai Song, Shenzhen (CN); Pei Dong, Shenzhen (CN)

(21) Appl. No.: 18/975,701

(22) Filed: Dec. 10, 2024

(30) Foreign Application Priority Data
Dec. 26, 2023 (CN) 202311816330.3

(51) Int. Cl. G06T 11/60; G06V 10/77; G06V 10/776; G06V 10/778; G06V 10/82; G06V 40/16

(52) U.S. Cl. CPC G06T 11/60; G06V 10/7715; G06V 10/776; G06V 10/778; G06V 10/82; G06V 40/171

(57) ABSTRACT

An image generation method includes: generating multiple sets of paired data using a trained first model, each set of the multiple sets of paired data including a first face image and a first cartoon image corresponding to the first face image; training a second model based on the plurality of sets of paired data to obtain a trained second model; and inputting a second face image to be processed into the trained second model to obtain a second cartoon image corresponding to the second face image.

### CROSS REFERENCE TO RELATED APPLICATIONS

This application claims priority to Chinese Patent Application No. CN 202311816330.3, filed Dec. 26, 2023, which is hereby incorporated by reference herein as if set forth in its entirety.

### TECHNICAL FIELD

The present disclosure generally relates to image processing technologies, and in particular relates to an image generation method and device and computer-readable storage medium.

### BACKGROUND

Facial cartoonization refers to generating cartoon images based on face images. Facial cartoonization technology can make human-computer interaction more friendly and natural, enhance the interactive experience of digital collaboration, and improve user engagement in educational and entertainment scenarios.

Currently, facial cartoonization is achieved by using a trained image generation model to obtain the cartoon image corresponding to a face image. However, due to the difficulty in obtaining sample images for training image generation models in practical applications, the accuracy of the image generation models is often low, resulting in cartoon images that differ significantly from the real face images.

Therefore, there is a need to provide an image generation method to overcome the above-mentioned problems.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a device for generating cartoon images according to one embodiment.

FIG. 2 is a schematic diagram of a training model provided according to one embodiment.

FIG. 3 is a schematic diagram of a training architecture of a first model according to one embodiment.

FIG. 4 is a schematic diagram of a training architecture of the first model according to another embodiment.

FIG. 5 is a schematic diagram of a module structure of a generation network according to one embodiment.

FIG. 6 is a schematic diagram of a training architecture of a second model according to one embodiment.

FIG. 7 is an exemplary flowchart of an image generation method according to one embodiment.

FIG. 8 is an exemplary block diagram of an image generation device according to another embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

Facial cartoonization refers to generating cartoon images based on face images. Facial cartoonization technology can make human-computer interaction more friendly and natural, enhance the interactive experience of digital collaboration, and improve user engagement in educational and entertainment scenarios.

Currently, facial cartoonization is achieved by using a trained image generation model to obtain the cartoon image corresponding to a face image. However, due to the difficulty in obtaining sample images for training image generation models in practical applications, the accuracy of the image generation models is often low, resulting in cartoon images that differ significantly from the real face images.

To address the above problem, the present disclosure provides an image generation method. As an example, but not a limitation, the method can be implemented by a device 10. The device 10 can be a desktop computer, laptop, handheld device, cloud server, or other computing device.

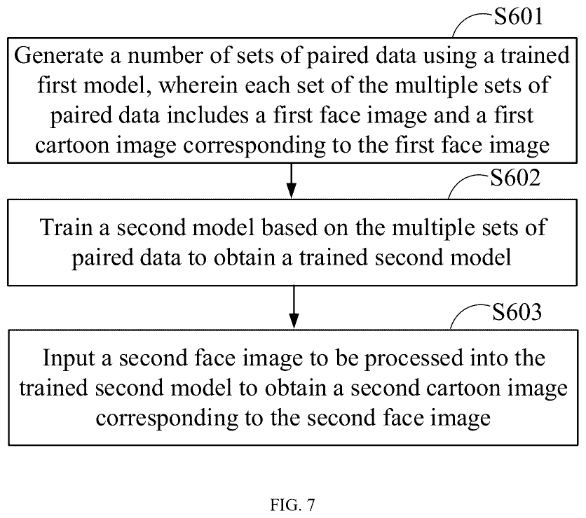

In one embodiment, the device 10 may include a processor 101, a storage 102, and one or more executable computer programs 103 that are stored in the storage 102. The storage 102 and the processor 101 are directly or indirectly electrically connected to one another to realize data transmission or interaction. For example, they can be electrically connected to one another through one or more communication buses or signal lines. The processor 101 performs corresponding operations by executing the executable computer programs 103 stored in the storage 102. When the processor 101 executes the computer programs 103, the steps in the embodiments of the image generation method, such as steps S601 to S603 in FIG. 7 are implemented.

The processor 101 may be an integrated circuit chip with signal processing capability. The processor 101 may be a central processing unit (CPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the device 10, such as a hard disk or a memory. The storage 102 may also be an external storage device of the device 10, such as a plug-in hard disk, a smart memory card (SMC), and a secure digital (SD) card, or any suitable flash cards. Furthermore, the storage 102 may also include both an internal storage unit and an external storage device. The storage 102 is to store computer programs, other programs, and data required by the device 10. The storage 102 can also be used to temporarily store data that have been output or is about to be output.

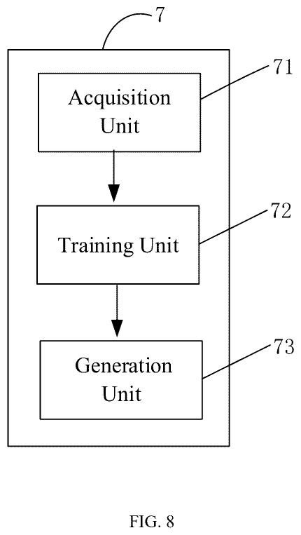

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the device 10. For example, the one or more computer programs 103 may be divided into an acquisition unit 71, a training unit 72 and a generation unit 73 as shown in FIG. 8.

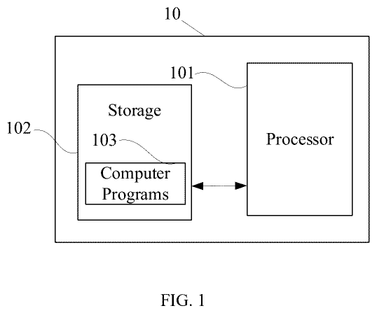

It should be noted that the block diagram shown in FIG. 1 is only an example of the device 10. The device 10 may include more or fewer components than what is shown in FIG. 1, or have a different configuration than what is shown in FIG. 1. Each component shown in FIG. 1 may be implemented in hardware, software, or a combination thereof.

In one embodiment, multiple sets of paired data can be generated by a trained first model, and the second model for generating cartoon images can be trained using the multiple sets of paired data. With such an approach, the problem of difficulty in obtaining sample images is effectively solved, and the second model is trained using the generated paired data, which is conducive to improving the accuracy of the second model, thereby improving the generation effect of cartoon images. To facilitate explanation, the training models involved in the embodiments of the present disclosure will be introduced first.

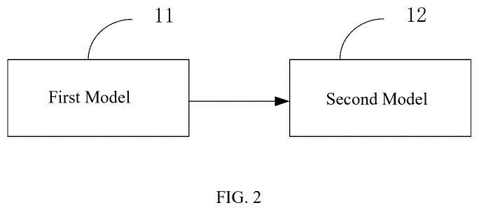

Refer to FIG. 2, which is a schematic diagram of a training model according to one embodiment. As an example, but not a limitation, the training model may include a first model 11 and a second model 12. During the training process, the first model 11 is first trained so that the first model 11 can generate relatively matching paired data. After obtaining the trained first model 11, multiple sets of paired data are obtained using the trained first model 11 as training data. Subsequently, the second model 12 is trained using the training data so that the second model 12 can generate a cartoon image that is relatively matching with a real face image. After obtaining the trained second model 12, the face image to be processed can be input into the trained second model 12, and a cartoon image matching the face image to be processed can then be output. In one embodiment, the second model 12 can be an edge deployment model.

It should be noted that the training process can be divided into two stages, the first stage is the training process of the first model 11, and the second stage is the training process of the second model 12. In the actual application process after training, the first model 11 is no longer needed, and only the second model 12 is needed to generate cartoon images. The training process of the first model 11 will introduced first.

In one embodiment, the first model 11 may include a first generation network and a second generation network. The first generation network is to generate cartoon images, and the second generation network is to generate real face images.

In one embodiment, the first model 11 can be trained using the training idea of a generative adversarial network (GAN). The GAN network includes a generator and a discriminator. The generator is responsible for learning to generate data similar to real data from random noise, and the discriminator is to distinguish between generated data and real data. The training process of the GAN network can be regarded as a process of “competition” between the generator and the discriminator. The generator learns to generate “realistic” data as much as possible, while the discriminator learns to distinguish between generated data and real data as accurately as possible. In other words, the training goal of the generator is to deceive the discriminator so that it cannot distinguish between generated data and real data. The training goal of the discriminator is to determine the authenticity of the input data as accurately as possible. This adversarial learning process continues until the data generated by the generator is realistic enough and the discriminator cannot effectively distinguish between real and false.

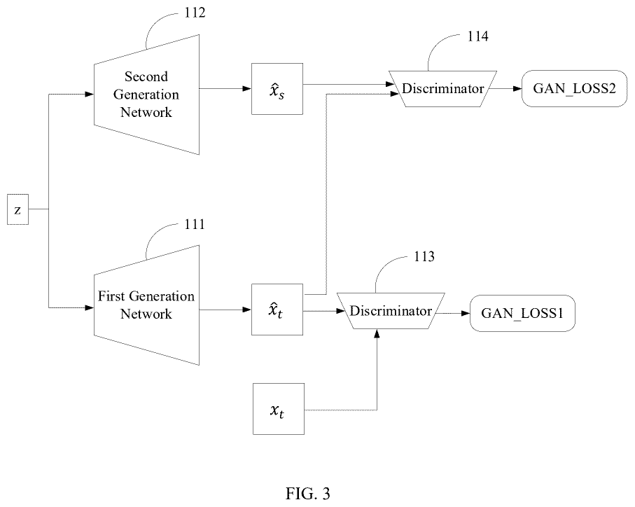

FIG. 3 is a schematic diagram of the training architecture of the first model according to one embodiment. As an example, but not a limitation, as shown in FIG. 3, the training architecture of the first model may include a first generation network 111, a second generation network 112, a discriminator 113 and a discriminator 114. The training data includes a cartoon image xₜ (i.e., sample image). During the training process, a first feature vector z related to the cartoon image xₜ is input into the first generation network 111, which outputs the generated cartoon image \hat{x}ₜ (i.e., third cartoon image). The cartoon image xₜ and the cartoon image \hat{x}ₜ are then input into the discriminator 113, which outputs the loss value GAN_LOSS1. The first feature vector z, related to the cartoon image xₜ, is then input into the second generation network 112, which outputs the generated face image Is (i.e., the third face image). The cartoon image xₜ and the face image xs are input into the discriminator 114, which outputs the loss value GAN_LOSS2. The total loss is calculated according to the loss values GAN_LOSS1 and GAN_LOSS2. if the total loss is less than or equal to a preset loss threshold, the current first generation network 111 and the second generation network 112 are determined as the trained first model 11. If the total loss is greater than the preset loss threshold, the model parameters of the first generation network 111 and the second generation network 112 are adjusted, and the first model is continuously trained according to the next cartoon image xₜ and its related first feature vector until the total loss of the first model is less than or equal to the preset loss threshold.

It should be noted that the above is only an example of training the first model. In practical applications, other training methods can also be used, such as controlling the number of iterations, etc. The embodiments of the present disclosure do not specifically limit the process of training the first model.

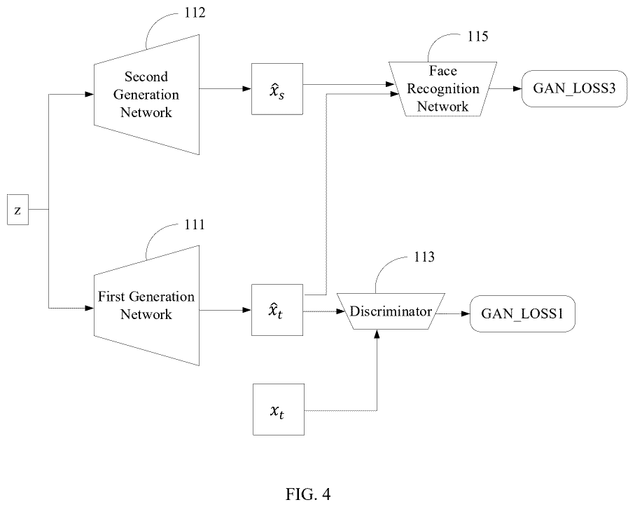

FIG. 4 is a schematic diagram of the training architecture of the first model according to another embodiment. As an example, but not a limitation, as shown in FIG. 4, the training architecture of the first model may include the first generation network 111, the second generation network 112, the discriminator 113, and a face recognition network 115. The training data includes a cartoon image xₜ (i.e., sample image). During the training process, the cartoon image xₜ and the cartoon image \hat{x}ₜ are input into the discriminator 113, which outputs the loss value GAN_LOSS1 (i.e., second sub-loss). The first feature vector z, related to the cartoon image xₜ, is then input into the second generation network 112, which outputs the generated face image xs. The cartoon image \hat{x}ₜ and the face image \hat{x}ₛ are input into the face recognition network 115 to obtain the feature information ƒeaₓₜ, (i.e., second feature vector) of the cartoon image \hat{x}ₜ and the feature information ƒeaₓₛ, (i.e., third feature vector) of the face image îs. Then the loss value GAN_LOSS3 (i.e., first sub-loss) is calculated based on the feature information feds, and the feature information feds. The total loss (i.e., first loss value) is then calculated based on the loss values GAN LOSS1 and GAN LOSS3. If the total loss is less than or equal to the preset loss threshold, the current first generation network 111 and the second generation network 112 are determined as the trained first model 11. If the total loss is greater than the preset loss threshold, the model parameters of the first generation network 111 and the second generation network 112 are adjusted, and the first model is continuously trained based on the next cartoon image \hat{x}ₜ and its related first feature vector until the total loss of the first model is less than or equal to the preset loss threshold.

In one embodiment, the loss value GAN_LOSS3 can be calculated according to the following equations:

$$Loss 2 = 1 - cosine ( {fea}_{{\hat{x}}_{s}} , {fea}_{{\hat{x}}_{t}} ) ; cosine ( {fea}_{{\hat{x}}_{s}} , {fea}_{{\hat{x}}_{t}} ) = \frac{{fea}_{{\hat{x}}_{s}} * {fea}_{{\hat{x}}_{t}}}{‖ {fea}_{{\hat{x}}_{s}} ‖ ‖ {fea}_{{\hat{x}}_{t}} ‖} .$$

In an embodiment of the present disclosure, a face recognition network is introduced, and feature constraints are performed on the feature information of the generated cartoon images and the generated face images through the face recognition network. In this way, the matching degree between the face images and the cartoon images can be improved, thereby improving the training accuracy of the first model.

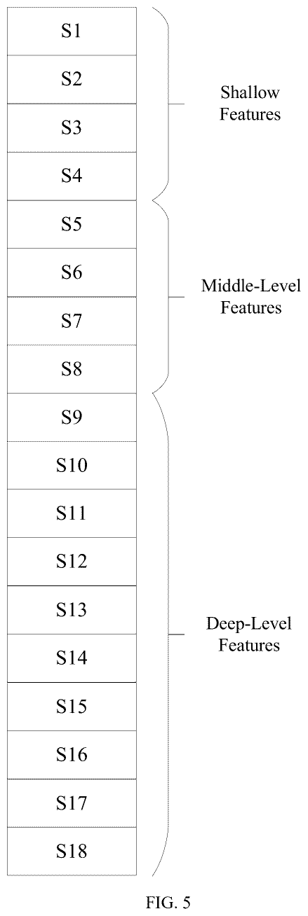

FIG. 5 is a schematic diagram of the module structure of the generation network according to one embodiment. As an example, but not a limitation, as shown in FIG. 5, the generation network includes 18 modules S1-S18. Specifically, the resolution of modules S1-S4 is relatively low, and they are used to extract shallow features such as facial posture, shape and hairstyle. The resolution of modules S5-S8 is higher than that of modules S1-S4, and they are used to extract fine middle-level features such as eye opening and closing. The resolution of modules S9-S18 is higher than that of modules S5-S8, and they are used to extract deep-level features such as texture and color of eyes, hair, and skin. After the first model training is completed, the first four modules S1-S4 of the current first generation network can be replaced with the first four modules S1-S4 of the current second generation network.

Since the first four modules S1-S4 of the generation network are used to extract shallow features of the face, through module replacement, the first generative network and the second generative network can maintain consistency in shallow features, which is conducive to improving the matching degree between the generated cartoon images and the generated face images. The training process of the second model 12 is described below.

Based on the training process of the first model 11 described above, the trained first model 11 is obtained. Multiple sets of paired data are obtained according to the trained first model 11, and then the second model 12 is trained using the multiple sets of paired data. In one embodiment, the second model can adopt a U-Net structure.

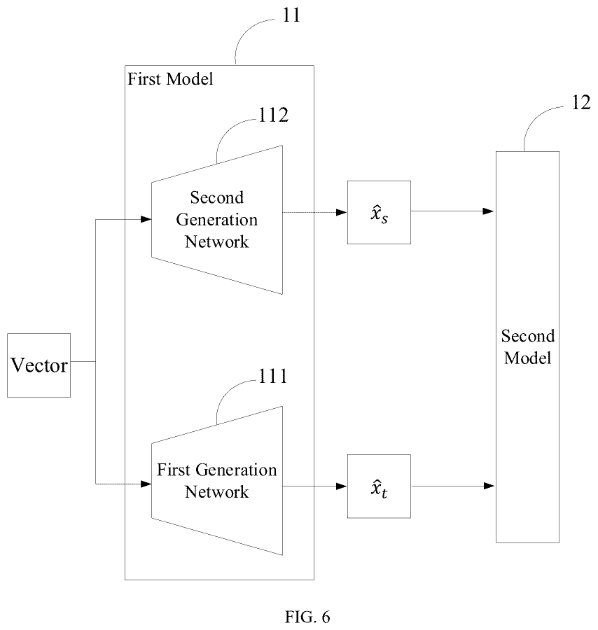

FIG. 6 is a schematic diagram of the training architecture of the second model according to one embodiment. As an example, but not a limitation, as shown in FIG. 6, the training architecture of the second model may include a first model 11 and a second model 12. During the training process, multiple sets of noise data vectors are first obtained. The noise data vectors are respectively input into the first generation network 111 and the second generation network 112 in the first model 11 to obtain the cartoon image \hat{x}ₜ (i.e., first cartoon image) output by the first generation network 111 and the face image \hat{x}ₛ (i.e., first face image) output by the second generation network 112. The generated cartoon image \hat{x}ₜ and face image \hat{x}ₛ are input into the second model 12. The second model 12 generates a cartoon image \hat{x}ₜ₀ to (i.e., fourth cartoon image) based on the face image \hat{x}ₛ. Then the loss value LOSS_4 (i.e., second loss value) of the second model 12 is calculated based on the cartoon image \hat{x}ₜ₀ and the cartoon image \hat{x}ₜ. If the loss value LOSS_4 is less than or equal to the preset loss threshold, the current second model 12 is determined as the trained second model. If the loss value LOSS_4 is greater than the preset loss threshold, the model parameters of the second model 12 are adjusted, and the second model 12 is continuously trained based on the next set of noise data until the loss value LOSS_4 of the second model 12 is less than or equal to the preset loss threshold. In one embodiment, the noise data can be random white noise or Gaussian noise, etc.

Since the trained first model can generate matching cartoon images and face images based on the noise data, it is equivalent to obtaining paired data. Using the paired data to train the second model is conducive to improving the training accuracy of the second model.

In one embodiment, the loss value LOSS_4 of the second model 12 may be calculated as follows: calculating a pixel difference between the cartoon image \hat{x}ₜ₀ (i.e., fourth cartoon image) and the cartoon image \hat{x}ₜ (i.e., first cartoon image) to obtain a third sub-loss; calculating a square difference between the pixels of the cartoon image \hat{x}ₜ₀ to (i.e., fourth cartoon image) and the cartoon image \hat{x}ₜ (i.e., first cartoon image) to obtain a fourth sub-loss; calculating the difference between a feature vector of the cartoon image \hat{x}ₜ₀ (i.e., fourth cartoon image) and a feature vector of the cartoon image \hat{x}ₜ (i.e., first cartoon image) to obtain a fifth sub-loss; and calculating the second loss value based on the third sub-loss, the fourth sub-loss and the fifth sub-loss.

In one embodiment, the third sub-loss, the fourth sub-loss, and the fifth sub-loss may be weightedly summed to obtain the second loss value.

In the above embodiment, the third sub-loss is to characterize the pixel difference between the two images, the fourth sub-loss is to characterize the reconstruction ability of the cartoon image generated by the second model, and the fifth sub-loss is to characterize the difference between the two images in the feature space. The calculation method of the above loss value is equivalent to measuring the difference between the two images from the three dimensions of pixels, semantics and features. Using such a loss value to train the second model is conducive to improving the training accuracy of the second model.

Based on the training process of the above model, the trained second model 12 can be obtained. Based on the trained second model 12, the process of image generation is described below.

FIG. 7 is a flowchart of an image generation method according to one embodiment. As an example, but not a limitation, the method may include the following steps.

Step S601: Generate a number of sets of paired data using a trained first model, wherein each set of the multiple sets of paired data includes a first face image and a first cartoon image corresponding to the first face image.

The training process of the first model can refer to the embodiment of the training process of the first model mentioned above, which will not be repeated here.

In one embodiment, step S601 may include: obtaining multiple sets of noise data; and for each set of the multiple sets of noise data, inputting the set of noise data into the first generation network and the second generation network of the trained first model, respectively, to obtain one of the first cartoon images output by the first generation network and one of the first face images output by the second generation network.

Step S602: Train a second model based on the multiple sets of paired data to obtain a trained second model.

The training process of step S602 can refer to the embodiment of the training process of the second model mentioned above, which will not be described in detail here.

Step S603: Input a second face image to be processed into the trained second model to obtain a second cartoon image corresponding to the second face image. The second face image to be processed may be a real face image.

In the embodiment above, multiple sets of paired data can be generated by a trained first model, and the second model for generating cartoon images can be trained using the multiple sets of paired data. With such an approach, the problem of difficulty in obtaining sample images is effectively solved, and the second model is trained using the generated paired data, which is conducive to improving the accuracy of the second model, thereby improving the generation effect of cartoon images.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

Corresponding to the image generating method described in the above embodiment, FIG. 8 is a schematic block diagram of the image generating device according to one embodiment. For the sake of convenience of explanation, only the part related to the embodiment of the present disclosure is shown.

In one embodiment, the device 7 may include an acquisition unit 71, a training unit 72 and a generation unit 73. The acquisition unit 71 is to generate a number of sets of paired data using a trained first model. Each set of the multiple sets of paired data includes a first face image and a first cartoon image corresponding to the first face image. The training unit 72 is to train a second model based on the multiple sets of paired data to obtain a trained second model. The generation unit 73 is to input a second face image to be processed into the trained second model to obtain a second cartoon image corresponding to the second face image.

In one embodiment, the first model includes a first generation network and a second generation network.

In one embodiment, the acquisition unit 71 is further to: obtain a sample image and a first feature vector corresponding to the sample image, wherein the sample image is a cartoon image; input the first feature vector into the first generation network to obtain a third cartoon image; input the first feature vector into the second generation network to obtain a third face image; calculate a first loss value based on the sample image, the third cartoon image and the third face image; in response to the first loss value being greater than a first threshold, update model parameters of the first model based on the first loss value to obtain an updated first model, and continue to train the updated first model based on a next sample image; and in response to the first loss value being less than or equal to the first threshold, determine the first model to be the trained first model.

In one embodiment, the acquisition unit 71 is further to: perform face recognition on the third cartoon image and the third face image respectively to obtain the second feature vector corresponding to the third cartoon image and the third feature vector corresponding to the third face image; calculate a first sub-loss based on the second feature vector and the third feature vector; calculate a second sub-loss based on the sample image and the third cartoon image; and calculate the first loss value based on the first sub-loss and the second sub-loss.

In one embodiment, the acquisition unit 71 is further to: replace first k modules of the first generation network in the first model with first k modules of the second generation network in the first model to obtain a replaced first generation network, wherein k is a positive integer less than N, and N is a total number of modules included in the first generation network; and determine the trained first model based on the second generation network and the replaced first generation network.

In one embodiment, the acquisition unit 71 is further to: obtain multiple sets of noise data; and for each set of the multiple sets of noise data, input the set of noise data into the first generation network and the second generation network of the trained first model, respectively, to obtain one of the first cartoon images output by the first generation network and one of the first face images output by the second generation network.

In one embodiment, the training unit 72 is further to: for each set of the multiple sets of paired data, input the first face image of the set of paired data into the second model to obtain a fourth cartoon image; calculate a second loss value based on the fourth cartoon image and the first cartoon image of the set of paired data; in response to the second loss value being greater than the second threshold, update model parameters of the second model based on the second loss value to obtain an updated second model, and continue to train the updated second model based on a next set of paired data; and in response to the second loss value being less than or equal to the second threshold, determine the second model to be the trained second model.

In one embodiment, the training unit 72 is further to: calculate a pixel difference between the fourth cartoon image and the first cartoon image to obtain a third sub-loss; calculate a square difference between the pixels of the fourth cartoon image and the first cartoon image to obtain a fourth sub-loss; calculate the difference between a feature vector of the fourth cartoon image and a feature vector of the first cartoon image to obtain a fifth sub-loss; and calculate the second loss value based on the third sub-loss, the fourth sub-loss and the fifth sub-loss.

It should be noted that content such as information exchange between the modules/units and the execution processes thereof is based on the same idea as the method embodiments of the present disclosure, and produces the same technical effects as the method embodiments of the present disclosure. For the specific content, refer to the foregoing description in the method embodiments of the present disclosure. Details are not described herein again

Each unit in the device discussed above may be a software program module, or may be implemented by different logic circuits integrated in a processor or independent physical components connected to a processor, or may be implemented by multiple distributed processors.

In addition, the device shown in FIG. 8 may be a software unit, a hardware unit, or a combination of software and hardware units built into an existing terminal device, or may be integrated into the terminal device as an independent widget, or may exist as an independent terminal device.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk. a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented image generation method, the method comprising:
generating a plurality of sets of paired data using a trained first model, wherein each set of the plurality of sets of paired data comprises a first face image and a first cartoon image corresponding to the first face image;
training a second model based on the plurality of sets of paired data to obtain a trained second model; and
inputting a second face image to be processed into the trained second model to obtain a second cartoon image corresponding to the second face image.

2. The method of claim 1, wherein a first model comprises a first generation network and a second generation network; the method comprises:
obtaining a sample image and a first feature vector corresponding to the sample image, wherein the sample image is a cartoon image;
inputting the first feature vector into the first generation network to obtain a third cartoon image;
inputting the first feature vector into the second generation network to obtain a third face image;
calculating a first loss value based on the sample image, the third cartoon image and the third face image;
in response to the first loss value being greater than a first threshold, updating model parameters of the first model based on the first loss value to obtain an updated first model, and continuing to train the updated first model based on a next sample image; and
in response to the first loss value being less than or equal to the first threshold, determining the first model to be the trained first model.

3. The method of claim 2, wherein calculating the first loss value based on the sample image, the third cartoon image and the third face image comprises:
performing face recognition on the third cartoon image and the third face image respectively to obtain the second feature vector corresponding to the third cartoon image and the third feature vector corresponding to the third face image;
calculating a first sub-loss based on the second feature vector and the third feature vector;
calculating a second sub-loss based on the sample image and the third cartoon image; and
calculating the first loss value based on the first sub-loss and the second sub-loss.

4. The method of claim 2, wherein determining the first model to be the trained first model comprises:
replacing first k modules of the first generation network in the first model with first k modules of the second generation network in the first model to obtain a replaced first generation network, wherein k is a positive integer less than N, and N is a total number of modules included in the first generation network; and
determining the trained first model based on the second generation network and the replaced first generation network.

5. The method of claim 2, wherein generating the plurality of sets of paired data using a trained first model comprises:
obtaining a plurality of sets of noise data; and
for each set of the plurality of sets of noise data, inputting the set of noise data into the first generation network and the second generation network of the trained first model, respectively, to obtain one of the first cartoon images output by the first generation network and one of the first face images output by the second generation network.

6. The method of claim 1, wherein training the second model based on the plurality of sets of paired data to obtain the trained second model comprises:
for each set of the plurality of sets of paired data, inputting the first face image of the set of paired data into the second model to obtain a fourth cartoon image;
calculating a second loss value based on the fourth cartoon image and the first cartoon image of the set of paired data;
in response to the second loss value being greater than the second threshold, updating model parameters of the second model based on the second loss value to obtain an updated second model, and continuing to train the updated second model based on a next set of paired data; and
in response to the second loss value being less than or equal to the second threshold, determining the second model to be the trained second model.

7. The method of claim 6, wherein calculating the second loss value based on the fourth cartoon image and the first cartoon image of the set of paired data comprises:
calculating a pixel difference between the fourth cartoon image and the first cartoon image to obtain a third sub-loss;
calculating a square difference between the pixels of the fourth cartoon image and the first cartoon image to obtain a fourth sub-loss;
calculating the difference between a feature vector of the fourth cartoon image and a feature vector of the first cartoon image to obtain a fifth sub-loss; and
calculating the second loss value based on the third sub-loss, the fourth sub-loss and the fifth sub-loss.

8. A device comprising:
one or more processors; and
a memory coupled to the one or more processors, the memory storing programs that, when executed by the one or more processors, cause performance of operations comprising:
generating a plurality of sets of paired data using a trained first model, wherein each set of the plurality of sets of paired data comprises a first face image and a first cartoon image corresponding to the first face image;
training a second model based on the plurality of sets of paired data to obtain a trained second model; and
inputting a second face image to be processed into the trained second model to obtain a second cartoon image corresponding to the second face image.

9. The device of claim 8, wherein a first model comprises a first generation network and a second generation network; the method comprises:
obtaining a sample image and a first feature vector corresponding to the sample image, wherein the sample image is a cartoon image;
inputting the first feature vector into the first generation network to obtain a third cartoon image;
inputting the first feature vector into the second generation network to obtain a third face image;
calculating a first loss value based on the sample image, the third cartoon image and the third face image;
in response to the first loss value being greater than a first threshold, updating model parameters of the first model based on the first loss value to obtain an updated first model, and continuing to train the updated first model based on a next sample image; and
in response to the first loss value being less than or equal to the first threshold, determining the first model to be the trained first model.

10. The device of claim 9, wherein calculating the first loss value based on the sample image, the third cartoon image and the third face image comprises:
performing face recognition on the third cartoon image and the third face image respectively to obtain the second feature vector corresponding to the third cartoon image and the third feature vector corresponding to the third face image;
calculating a first sub-loss based on the second feature vector and the third feature vector;
calculating a second sub-loss based on the sample image and the third cartoon image; and
calculating the first loss value based on the first sub-loss and the second sub-loss.

11. The device of claim 9, wherein determining the first model to be the trained first model comprises:
replacing first k modules of the first generation network in the first model with first k modules of the second generation network in the first model to obtain a replaced first generation network, wherein k is a positive integer less than N, and N is a total number of modules included in the first generation network; and
determining the trained first model based on the second generation network and the replaced first generation network.

12. The device of claim 9, wherein generating the plurality of sets of paired data using a trained first model comprises:
obtaining a plurality of sets of noise data; and
for each set of the plurality of sets of noise data, inputting the set of noise data into the first generation network and the second generation network of the trained first model, respectively, to obtain one of the first cartoon images output by the first generation network and one of the first face images output by the second generation network.

13. The device of claim 8, wherein training the second model based on the plurality of sets of paired data to obtain the trained second model comprises:
for each set of the plurality of sets of paired data, inputting the first face image of the set of paired data into the second model to obtain a fourth cartoon image;
calculating a second loss value based on the fourth cartoon image and the first cartoon image of the set of paired data;
in response to the second loss value being greater than the second threshold, updating model parameters of the second model based on the second loss value to obtain an updated second model, and continuing to train the updated second model based on a next set of paired data; and
in response to the second loss value being less than or equal to the second threshold, determining the second model to be the trained second model.

14. The device of claim 13, wherein calculating the second loss value based on the fourth cartoon image and the first cartoon image of the set of paired data comprises:
calculating a pixel difference between the fourth cartoon image and the first cartoon image to obtain a third sub-loss;
calculating a square difference between the pixels of the fourth cartoon image and the first cartoon image to obtain a fourth sub-loss;
calculating the difference between a feature vector of the fourth cartoon image and a feature vector of the first cartoon image to obtain a fifth sub-loss; and
calculating the second loss value based on the third sub-loss, the fourth sub-loss and the fifth sub-loss.

15. A non-transitory computer-readable storage medium storing instructions that, when executed by at least one processor of a device, cause the at least one processor to perform a method, the method comprising:
generating a plurality of sets of paired data using a trained first model, wherein each set of the plurality of sets of paired data comprises a first face image and a first cartoon image corresponding to the first face image;
training a second model based on the plurality of sets of paired data to obtain a trained second model; and
inputting a second face image to be processed into the trained second model to obtain a second cartoon image corresponding to the second face image.

16. The non-transitory computer-readable storage medium of claim 15, wherein a first model comprises a first generation network and a second generation network; the method comprises:
obtaining a sample image and a first feature vector corresponding to the sample image, wherein the sample image is a cartoon image;
inputting the first feature vector into the first generation network to obtain a third cartoon image;
inputting the first feature vector into the second generation network to obtain a third face image;
calculating a first loss value based on the sample image, the third cartoon image and the third face image;
in response to the first loss value being greater than a first threshold, updating model parameters of the first model based on the first loss value to obtain an updated first model, and continuing to train the updated first model based on a next sample image; and
in response to the first loss value being less than or equal to the first threshold, determining the first model to be the trained first model.

17. The non-transitory computer-readable storage medium of claim 16, wherein calculating the first loss value based on the sample image, the third cartoon image and the third face image comprises:
performing face recognition on the third cartoon image and the third face image respectively to obtain the second feature vector corresponding to the third cartoon image and the third feature vector corresponding to the third face image;
calculating a first sub-loss based on the second feature vector and the third feature vector;
calculating a second sub-loss based on the sample image and the third cartoon image; and
calculating the first loss value based on the first sub-loss and the second sub-loss.

18. The non-transitory computer-readable storage medium of claim 16, wherein determining the first model to be the trained first model comprises:
replacing first k modules of the first generation network in the first model with first k modules of the second generation network in the first model to obtain a replaced first generation network, wherein k is a positive integer less than N, and N is a total number of modules included in the first generation network; and
determining the trained first model based on the second generation network and the replaced first generation network.

19. The non-transitory computer-readable storage medium of claim 16, wherein generating the plurality of sets of paired data using a trained first model comprises:
obtaining a plurality of sets of noise data; and
for each set of the plurality of sets of noise data, inputting the set of noise data into the first generation network and the second generation network of the trained first model, respectively, to obtain one of the first cartoon images output by the first generation network and one of the first face images output by the second generation network.

20. The non-transitory computer-readable storage medium of claim 15, wherein training the second model based on the plurality of sets of paired data to obtain the trained second model comprises:
for each set of the plurality of sets of paired data, inputting the first face image of the set of paired data into the second model to obtain a fourth cartoon image;
calculating a second loss value based on the fourth cartoon image and the first cartoon image of the set of paired data;
in response to the second loss value being greater than the second threshold, updating model parameters of the second model based on the second loss value to obtain an updated second model, and continuing to train the updated second model based on a next set of paired data; and
in response to the second loss value being less than or equal to the second threshold, determining the second model to be the trained second model.
